(19) United States
(12) Patent Application Publication
(10) Pub. No.: US 2018/0209905 A1
(43) Pub. Date: Jul. 26, 2018

(54) SUPER-RESOLUTION MICROSCOPE

(71) Applicants: OLYMPUS CORPORATION, Tokyo (JP); UNIVERSITY OF TSUKUBA, Ibaraki (JP)

(72) Inventors: Yoshinori IKETAKI, Tokyo (JP); Hideaki KANOU, Tsukuba-shi (JP)

(73) Assignees: OLYMPUS CORPORATION, Tokyo (JP); UNIVERSITY OF TSUKUBA, Ibaraki (JP)

(21) Appl. No.: 15/834,230

(22) Filed: Dec. 7, 2017

(30) Foreign Application Priority Data
Jan. 23, 2017 (JP) 2017-009290

(51) Int. Cl. G01N 21/63; G02B 21/00; G02B 6/42; G02B 27/58; G01N 21/65

(52) U.S. Cl. CPC G01N 21/636; G02B 21/0032; G02B 6/4298; G02B 27/58; G02B 6/06; G02B 21/0048; G01N 2021/655; G01N 2021/637; G01N 21/65

(57) ABSTRACT

A super-resolution microscope includes an illuminator that irradiates illumination beams of colors of different wavelengths through an objective lens onto a sample while causing the illumination beams to overlap at least spatially and a detector that detects a signal beam generated by the sample through irradiation with the illumination beams. As the illumination beams, the illuminator irradiates first and second illumination beams onto the sample from the same direction. The first illumination beam includes multiple wavelengths or monochromatic light for inducing a nonlinear optical effect in the sample. The second illumination beam has a different wavefront distribution on a converging surface of the objective lens or a different spatial distribution of an electrical field vector than the first illumination beam and suppresses induction of the nonlinear optical effect. The detector detects a signal beam generated by the sample as a result of the nonlinear optical effect.

### CROSS-REFERENCE TO RELATED APPLICATION

The present application claims priority from Japanese Application No. 2017-009290, filed on Jan. 23, 2017, the content of which is incorporated herein by reference.

### TECHNICAL FIELD

This disclosure relates to a super-resolution microscope.

### BACKGROUND

One known example of a super-resolution microscope is a fluorescence microscope that uses a double-resonance absorption process to allow observation, at high spatial resolution exceeding the diffraction limit, of a sample including molecules that have at least two or more excited quantum states (for example, see Patent Literature (PTL) 1 and 2).

With the molecules in the sample in a stable state, the fluorescence microscope disclosed in PTL 1 and PTL 2 spatially scans the sample surface with a fluorescence spot that is shrunk to the diffraction limit or lower, for example using a combination of pump light for excitation from a ground state S₀ to a first quantum state S₁and erase light for causing molecules to transition further to another quantum state. A fluorescence image with resolution exceeding the spatial resolution at the diffraction limit is then obtained by two-dimensionally arranging the fluorescence signal at each measurement point on a computer and performing image processing.

As a representative example, the pump light is irradiated onto a sample including fluorophores, and the fluorophores are excited to a first electronically-excited state. The molecules in the first electronically-excited state are quenched by further irradiating the sample with the erase light to force the fluorophores to transition to another quantum state. As a result, fluorescence relaxation from the first electronically-excited state is controlled. By simultaneously irradiating a sample with pump light and a hollow erase light with an objective lens, the fluorescence spot formed on the sample surface that is dyed with fluorescent dye is shrunk to the diffraction limit or lower, leaving behind the central portion.

### CITATION LIST

### Patent Literature

PTL 1: JP 2001-100102 A

PTL 2: JP 2010-15026 A

### SUMMARY

To this end, a super-resolution microscope according to this disclosure includes:

an illuminator configured to irradiate illumination beams of a plurality of colors of different wavelengths through an objective lens onto a sample while causing the illumination beams to overlap at least spatially; and

a detector configured to detect a signal beam generated by the sample as a result of irradiation of the sample with the illumination beams, wherein

the illuminator irradiates a first illumination beam and a second illumination beam onto the sample from the same direction as the illumination beams, the first illumination beam comprising a plurality of wavelengths or monochromatic light for inducing a nonlinear optical effect in the sample, and the second illumination beam having a different wavefront distribution on a converging surface of the objective lens or a different spatial distribution of an electrical field vector than the first illumination beam and suppressing induction of the nonlinear optical effect, and

the detector detects a signal beam generated by the sample as a result of the nonlinear optical effect.

The nonlinear optical effect may be generated during a process selected from the group consisting of a second-order nonlinear optical process, a third-order nonlinear optical process, a fourth-order nonlinear optical process, and a fifth-order nonlinear optical process,

the second-order nonlinear optical process may be selected from the group consisting of second harmonic generation, sum frequency generation, difference frequency generation, and an optical parametric process,

the third-order nonlinear optical process may be selected from the group consisting of third harmonic generation, third-order sum frequency generation, coherent anti-Stokes Raman scattering, stimulated Raman scattering, stimulated Raman gain, stimulated Raman loss, optical Kerr effect, Raman induced Kerr effect, stimulated Rayleigh scattering, stimulated Brillouin scattering, stimulated Kerr scattering, stimulated Rayleigh-Bragg scattering, stimulated Mie scattering, self phase modulation, cross phase modulation, optical-field induced birefringence, and electric-field induced second harmonic generation,

the fourth-order nonlinear optical process may be four-wave mixing, and

the fifth-order nonlinear optical process may be selected from the group consisting of hyper-Raman scattering, hyper-Rayleigh scattering, and coherent anti-Stokes hyper-Raman scattering.

The second illumination beam may have a minimum in an intensity distribution on the converging surface.

The first illumination beam may have a maximum in the intensity distribution on the converging surface.

The first illumination beam and the second illumination beam may be coherent beams, and

the illuminator may comprise a spatial modulator configured to modulate a phase or a spatial distribution of an electrical field vector of the second illumination beam.

The spatial modulator may modulate the phase or the spatial distribution of the electric field vector of only the second illumination beam when the first illumination beam and the second illumination beam are coaxially incident.

The illuminator may cause the maximum of the first illumination beam and the minimum of the second illumination beam to overlap coaxially at the converging surface.

The detector may detect forward scattered light from the sample as the signal beam.

The nonlinear optical effect may be selected from the group consisting of a nonlinear Raman effect, a second-order or third-order sum frequency generation effect, and a second-order or third-order difference frequency generation effect.

The first illumination beam may comprise illumination beams of at least two colors of different wavelengths, and the illumination beams of at least two colors may have respective maximums in the intensity distribution on the converging surface.

The spatial modulator may change the phase of the second illumination beam from 0 to 2π, or an integer multiple thereof, over one revolution centering on an optical axis of the second illumination beam.

The spatial modulator may include a plurality of concentric regions centering on an optical axis of the second illumination beam and invert a sign of the phase of the second illumination beam in a radial direction between adjacent regions.

In each of the regions, the spatial modulator may change the phase of the second illumination beam from 0 to 2π, or an integer multiple thereof, over one revolution centering on the optical axis of the second illumination beam.

The spatial modulator may invert a direction of the electrical field vector of the second illumination beam at positions symmetrical about an optical axis of the second illumination beam.

The spatial modulator may include a plurality of concentric regions centering on an optical axis of the second illumination beam and invert a direction of the electrical field vector of the second illumination beam between adjacent regions.

The illuminator may be capable of changing a wavelength of each of the first illumination beam and the second illumination beam.

The second illumination beam may have a wavelength interval in a finite band.

A wavelength of the second illumination beam may be shorter than a wavelength at an absorption end due to electronic transition of a molecule to be observed in the sample.

The illuminator may comprise a plurality of light source points, and the first illumination beam and the second illumination beam may be extracted from the plurality of light source points and irradiated onto the sample, and

the detector may be configured to separate and detect a plurality of the signal beams generated by the sample in correspondence with the plurality of light source points.

The plurality of light source points may comprise an emission tip of a multi-fiber bundle in which fibers of a plurality of super continuum light sources are bundled together, and

the detector may comprise a two-dimensional detector including pixels equal to or greater in number than the number of fibers in the multi-fiber bundle.

### BRIEF DESCRIPTION OF THE DRAWINGS

In the accompanying drawings:

FIG. 1 is an energy diagram of a CARS process;

FIG. 2 illustrates the configuration of a super-resolution microscope according to Embodiment 1;

FIG. 3 is a schematic configuration drawing of a first example of a spatial modulator;

FIG. 4 is a schematic configuration drawing of a second example of a spatial modulator;

FIG. 5 is a schematic configuration drawing of a third example of a spatial modulator;

FIG. 6 is a schematic configuration drawing of a fourth example of a spatial modulator;

FIG. 7 is a schematic configuration drawing of a fifth example of a spatial modulator;

FIG. 8 is a schematic configuration drawing of a sixth example of a spatial modulator;

FIG. 9 is a schematic configuration drawing of a seventh example of a spatial modulator;

FIG. 10 is an excitation diagram in the super-resolution microscope of FIG. 1;

FIG. 11A illustrates the intensity distribution of a concentrated light pattern on the focal plane of quench light when using a line-oscillation laser beam;

FIG. 11B illustrates the intensity distribution of a concentrated light pattern on the focal plane of quench light when using a white laser beam from a super continuum light source;

FIG. 12 illustrates the configuration of a super-resolution microscope according to Embodiment 2; and

FIG. 13 is an excitation diagram illustrating a modification of this disclosure.

### DETAILED DESCRIPTION

With a super-resolution microscope, a sample needs to be dyed with fluorophores. Therefore, in particular when observing a live biological sample, the dye molecules affect the metabolism and the like of the biological sample, which may make it impossible to observe the natural biological phenomena of the biological sample.

A super-resolution microscope preferably obtains spatial resolution exceeding the diffraction limit without dye.

The super-resolution microscope according to this disclosure can observe a sample at super resolution by detecting a signal beam emitted from the sample by a nonlinear optical effect. The nonlinear optical effect may, for example, be generated during any of the following processes: a second-order nonlinear optical process, a third-order nonlinear optical process, a fourth-order nonlinear optical process, and a fifth-order nonlinear optical process.

The second-order nonlinear optical process includes, for example, any of second harmonic generation (SHG), sum frequency generation (SFG), difference frequency generation (DFG), and an optical parametric process.

The third-order nonlinear optical process includes, for example, any of third harmonic generation (THG), third-order sum frequency generation (TSFG), coherent anti-Stokes Raman scattering (CARS), stimulated Raman scattering (SRS; stimulated Raman gain (SRG), stimulated Raman loss (SRL)), optical Kerr effect (OKE), Raman induced Kerr effect (RIKE), stimulated Rayleigh scattering, stimulated Brillouin scattering (SBS), stimulated Kerr scattering, stimulated Rayleigh-Bragg scattering, stimulated Mie scattering, self phase modulation (SPM), cross phase modulation (XPM), optical-field induced birefringence, and electric-field induced SHG.

The fourth-order nonlinear optical process includes, for example, four-wave mixing (FWM).

The fifth-order nonlinear optical process includes, for example, any of hyper-Raman scattering, hyper-Rayleigh scattering, and coherent anti-Stokes hyper-Raman scattering.

In one embodiment of this disclosure, a CARS process that is a third-order nonlinear optical process is used as a nonlinear optical process. The CARS process is a representative nonlinear optical process that currently is the most widely used vibrational spectroscopy technique.

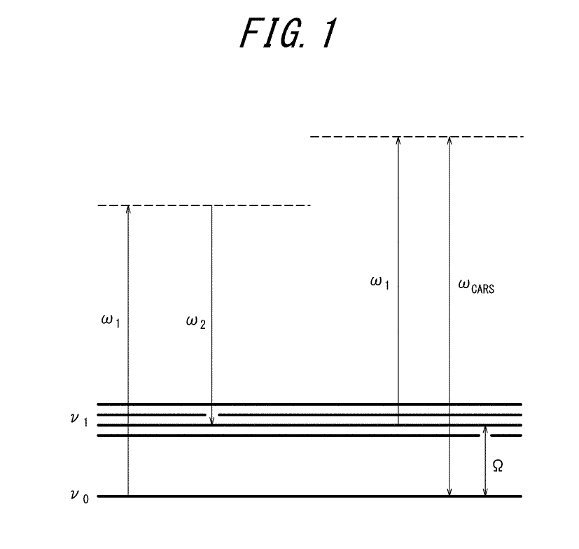

FIG. 1 is an energy diagram of the CARS process. In the CARS process, two laser beams (ω₁ beam, ω₂ beam) with different angular frequencies are typically used. The ω₁ beam is also referred to as pump light and excites a molecule at a vibrational level ν₀ to a higher excited state than a vibrational level ν₁. The ω₂ beam is also referred to as Stokes light and deexcites the molecule excited by the pump light ω₁ to the vibrational level ν₁. If the difference in angular frequency ω₁−ω₂ between these two incident beam matches the angular frequency Ω of the vibration mode of the sample molecules, then the vibration mode of multiple sample molecules is simultaneously excited.

The molecular vibration (vibration coherence) generated in this way is extracted as an ω_{CARS} beam (CARS beam) originating in third-order nonlinear polarization through the interaction between the molecule and a third laser beam ω₃ beam or probe light). In the CARS process, the condition ω_{CARS}=ω₁−ω₂+ω₃ is satisfied by the law of conservation of energy. Furthermore, the CARS beam is generated in the direction k_{CARS}=k₁−k₂+k₃ by a phase matching condition. Here, kₓ is a wavenumber vector of the ωₓ beam.

In the CARS process, the ω₁ beam is often used as the ω₃ beam. In other words, the pump light is used as the probe light. In this case, the angular frequency of the CARS beam becomes (2ωᵢ−ω₂). The signal intensity of the CARS beam is proportional to the second power of the intensity of the ω₁ beam and the first power of the intensity of the ω₂ beam. In other words, the signal intensity of the CARS beam increases nonlinearly with respect to the intensity of the ω₁ beam. Raman scattered light (CARS beam) with good directionality can be obtained by the CARS process from the phase matching condition. In particular, since the forward scattered light is characteristically intense, an image can be acquired at a fast measurement rate.

The CARS process is excellent in that it detects scattered light caused by the vibrational level of a molecule to be observed, thereby allowing detection of the existence of the molecule without performing dyeing. This process is convenient for detecting biological molecules of a biological sample in its natural state, without subjecting the live sample to chemical treatment.

### Embodiment 1

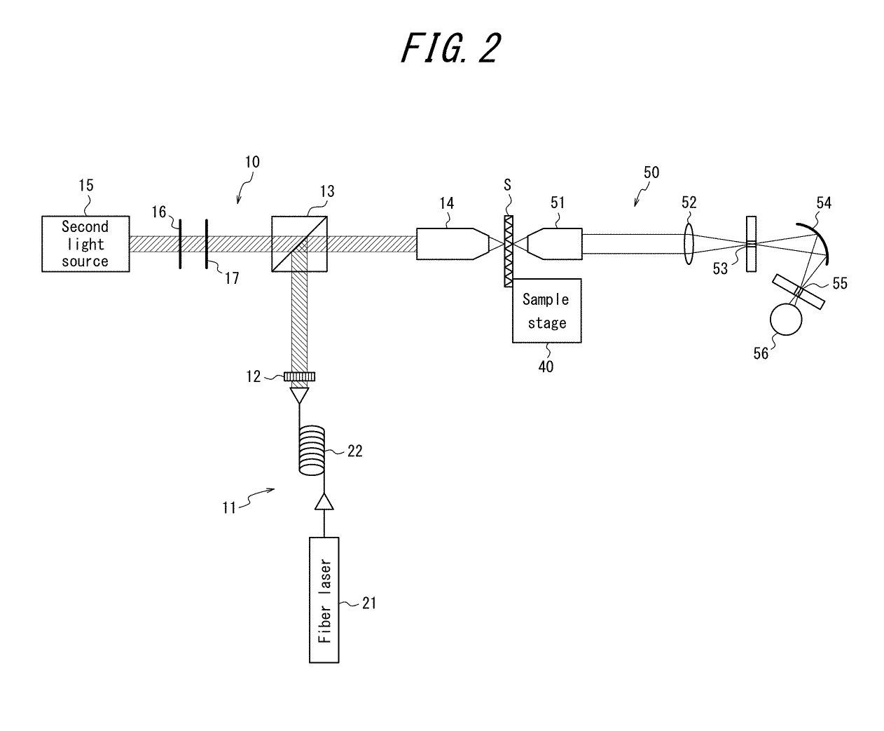

FIG. 2 illustrates the configuration of a super-resolution microscope according to Embodiment 1 of this disclosure. The super-resolution microscope illustrated in FIG. 2 constitutes a CARS microscope and includes an illuminator 10 and a detector 50. The illuminator 10 includes a first light source 11, a multi-bandpass filter 12, a beam combiner 13, an objective lens 14, a second light source 15, a quarter-wave plate 16, and a spatial modulator 17.

The first light source 11 emits a first illumination beam that induces the CARS process in a sample S. In this embodiment, the first light source 11 is constituted by one super continuum light source. Pump light (probe light) and Stokes light corresponding to the ω₁ beam and the ω₂ beam, which become the first illumination beam, are generated from the beam emitted from the super continuum light source. The super continuum first light source 11 includes, for example, a fiber laser 21 that emits 1560 nm wavelength femtosecond pulsed light and a photonic crystal fiber 22 that emits a white laser beam with the beam emitted by the fiber laser 21 as a seed beam.

The white laser beam emitted from the photonic crystal fiber 22 is incident on the multi-bandpass filter 12, and the pump light (probe light) and Stokes light are extracted spectrally. In this embodiment, the 1560 nm wavelength seed beam that is incident on the photonic crystal fiber 22 from the fiber laser 21 is used as the pump light (probe light) corresponding to the ω₁ beam. Accordingly, the pump light (probe light) can induce a CARS process that has a sufficiently high initial value and is a sufficient nonlinear optical process. The Stokes light corresponding to the ω₂ beam uses 2021 nm wavelength light.

The ω₁ beam and the ω₂ beam extracted from the multi-bandpass filter 12 pass through the beam combiner 13, are incident on the objective lens 14, and are focused on the sample S. Here, the ω₁ beam and the ω₂ beam focused on the sample S have a maximum value in the intensity distribution on the converging surface with a Gaussian beam. As a result, the CARS beam caused by the fundamental vibration of the CH chemical group of a particular organic molecule in the sample S can be selectively induced.

The second light source 15 emits a second illumination beam (also referred to as quench light) that has a different wavefront distribution on the converging surface of the objective lens 14 than the first illumination beam of the ω₁ beam and the ω₂ beam and that suppresses induction of the CARS process. A variable wavelength femtosecond laser, for example, is used in the second light source 15. The quench light emitted from the second light source 15 is converted to circularly polarized light by the quarter-wave plate 16, subsequently passes through the spatial modulator 17 and is incident on the beam combiner 13, is combined coaxially with the first illumination beam, and is focused on the sample S by the objective lens 14. The wavelength of the quench light is, for example, shorter than the wavelength at the absorption end due to electronic transition of the molecule to be observed in the sample S.

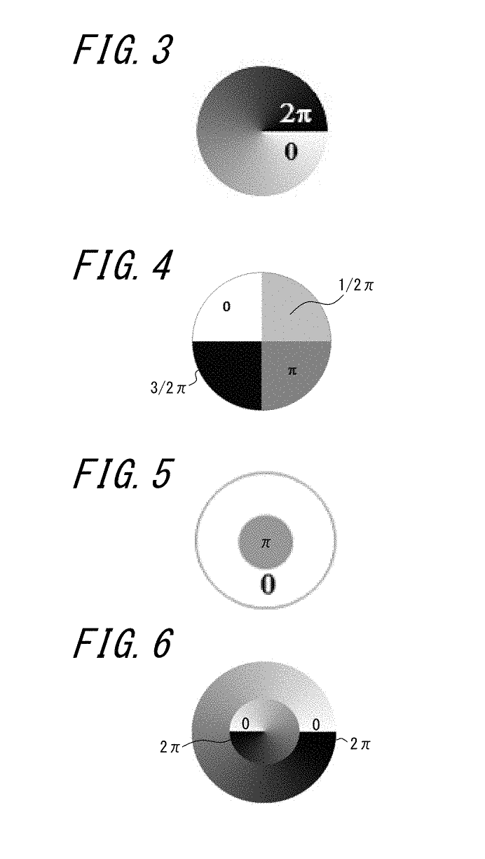

The spatial modulator 17 is, for example, configured as illustrated in FIG. 3 or FIG. 4. The spatial modulator 17 illustrated in FIG. 3 continuously changes the phase of the quench light from 0 to 2π (or an integer multiple thereof) over one revolution centering on the optical axis. The spatial modulator 17 illustrated in FIG. 4 includes four independent regions around the optical axis and changes the phase of the quench light in steps of π/2 (or an integer multiple thereof) from 0 to 2π (or an integer multiple thereof) centering on the optical axis.

Upon the quench light passing through the spatial modulator 17 in FIG. 3 or FIG. 4, the phase of the quench light is inverted between points symmetrical about the optical axis. Accordingly, upon focusing the quench light with the objective lens 14, a hollow beam spot that has a minimum in the intensity distribution on the converging surface is formed (for example, see “Formation of a doughnut laser beam for super-resolving microscopy using a phase spatial light modulator”, T. Watanabe, Y. Igasaki, N. Fukuchi, M. Sakai, S. Ishiuchi, M. Fujii, T. Omatsu, K. Yamamoto and Y. Iketaki, Opt. Eng., 43(2004) 1136).

The spatial modulator 17 may, for example, be configured as illustrated in FIG. 5 or FIG. 6. The spatial modulator 17 illustrated in FIG. 5 has a plurality (two in FIG. 5) of concentric regions centering on the optical axis of the quench light and inverts the sign of the phase of the quench light in the radial direction between adjacent regions. As in FIG. 5, the spatial modulator 17 illustrated in FIG. 6 inverts the sign of the phase of the quench light in the radial direction between adjacent concentric regions and also changes the phase of the quench light within each region from 0 to 2π or an integer multiple thereof over one revolution centering on the optical axis, as in FIG. 3.

Upon the quench light passing through the spatial modulator 17 illustrated in FIG. 5 or FIG. 6, the phase of the quench light is inverted in the radial direction. Therefore, upon focusing this quench light with the objective lens 14, a hollow beam spot that has a minimum in the intensity distribution on the converging surface is formed, as in the case of FIG. 3 and FIG. 4. Furthermore, in this case, the electrical field of the quench light is three-dimensionally offset, thereby generating a three-dimensional microspace located only at and around the focal point, where no light reaches (for example, see WO2005038441A1).

The spatial modulators 17 illustrated in FIG. 3 through FIG. 6 have a simple structure and can, for example, be produced with an optical thin film, with etching, or the like (for example, see “Three-dimensional super-resolution microscope using two-color annular phase plate”, Y. Iketaki, Appl. Phys. Express, 3 (2010) 085203; “New Design Method for a Phase Plate in Super-Resolution Fluorescence Microscopy”, N. Bokor and Y. Iketaki, Appl. Spectroscopy. 68(2014) 353; “Generation of a doughnut-shaped beam using a spiral phase plate”, T. Watanabe, M. Fujii, Y. Watanabe, N. Nobuhito and Y. Iketaki, Rev. Sci. Instrum. 75(2004) 5132).

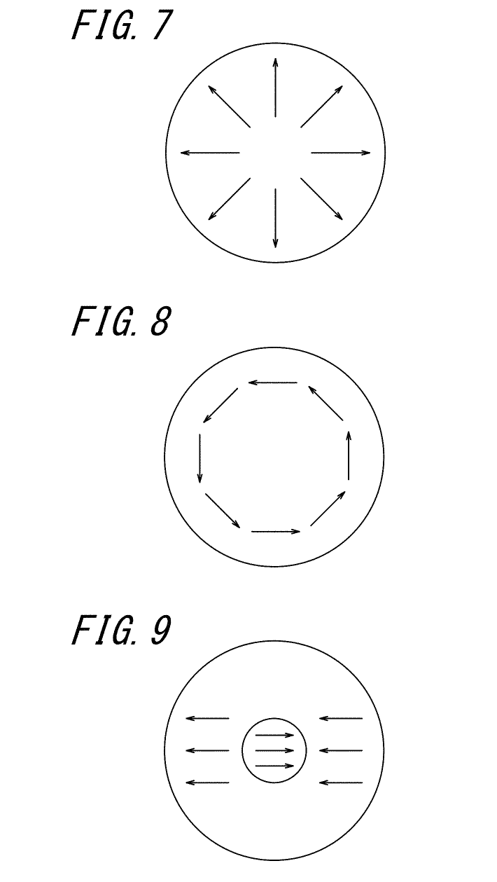

The spatial modulator 17 is not limited to the above-described case of modulating the phase of the quench light. A hollow beam spot that has a minimum in the intensity distribution on the converging surface can similarly be formed by modulating the polarization of the quench light. FIG. 7 through FIG. 9 schematically illustrate the configuration of spatial modulators 17 that modulate the polarization of the quench light. The spatial modulators 17 illustrated in FIG. 7 and FIG. 8 are configured to invert the direction of the electrical field vector of the quench light at positions symmetrical about the optical axis. The spatial modulator 17 illustrated in FIG. 9 has a plurality (two in FIG. 9) of concentric regions centering on the optical axis of the quench light and inverts the direction of the electrical field vector of the quench light between adjacent regions. The spatial modulators 17 in FIG. 7 through FIG. 9 can easily be produced by pasting waveplates together.

In FIG. 2, upon focusing the quench light that is coaxially combined by the beam combiner 13, the pump light (probe light), and the Stokes light on the sample S with the objective lens 14, a CARS beam can be induced at high resolution. In other words, since the CARS process due to the pump light (probe light) and the Stokes light is inhibited at the annular portion of the quench light that is focused to be hollow, the region where the CARS beam is generated becomes smaller than the diffraction limit-sized focused spot of the pump light (probe light) and the Stokes light.

The sample S is mounted on a sample stage 40 that can be displaced three dimensionally, i.e. in the z-direction along the optical axis of the objective lens 14 and in the x-direction and the y-direction that are orthogonal to each other in a plane orthogonal to the z-direction.

The detector 50 includes a collector lens 51, a focusing lens 52, a confocal pinhole 53, a spectroscope 54, a spectroscope split 55, and a photomultiplier 56. The collector lens 51 is struck by a CARS beam, which is forward scattered light of the sample S, and converts the CARS beam to a parallel beam. The CARS beam converted to a parallel beam by the collector lens 51 is focused by the focusing lens 52, passes through the confocal pinhole 53, and is incident on the spectroscope 54. The CARS beam is then dispersed by the spectroscope 54, and a desired wavelength component is extracted by the spectroscope split 55 and detected by the photomultiplier 56. Here, the confocal pinhole 53 does not only function as a spatial filter but also functions to improve the monochromaticity of the CARS beam.

The region where the CARS beam is formed by the three colors of the pump light (probe light), Stokes light, and quench light being focused substantially functions as a light probe. Accordingly, by spatially scanning the sample S against this light probe, the CARS beam can be imaged from the sample S at a spatial resolution exceeding the diffraction limit without dyeing. Specifically, while spatially scanning the sample stage 40, the CARS signal detected by the photomultiplier 56 from the sample S is mapped. For example, a super-resolution microscopic image is obtained by planar scanning. Since the confocal pinhole 53 is provided in this embodiment, the three-dimensional super-resolution microscopic image can be obtained by spatially scanning in the xy-directions while displacing the sample stage 40 in the z-direction.

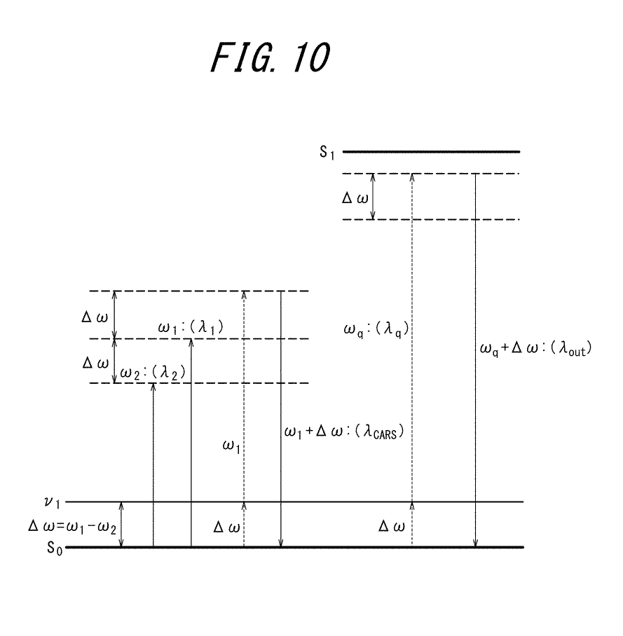

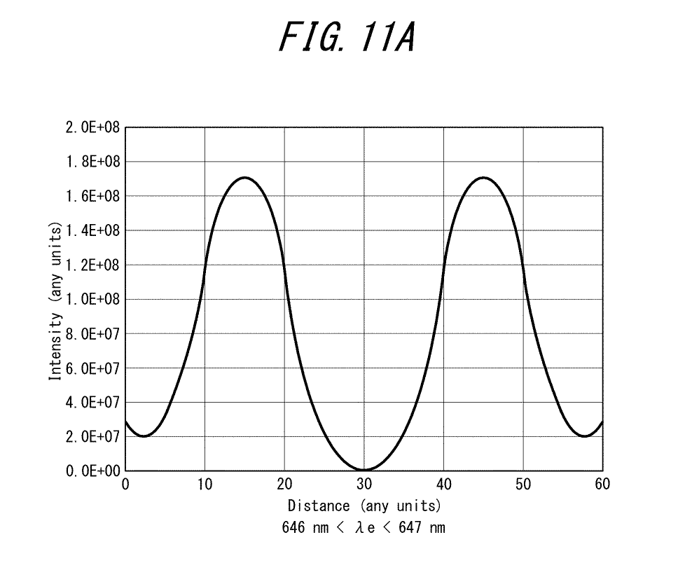

FIG. 10 is an excitation diagram in the super-resolution microscope according to this embodiment. From a different perspective, the CARS process can be considered a two-stage excitation process, with the vibrational level ν₁ as an intermediate level. First, a molecule at the ground state S₀ is excited to the vibrational level ν₁ by the difference in frequency component (Δω) generated by coherent overlapping of the pump light (angular frequency: ω₁, wavelength: λ₁) and the Stokes light (angular frequency: ω₂, wavelength: λ₂). The anti-Stokes (CARS) beam from the molecule in this intermediate state due to irradiation of the probe light (ω₁) is considered to have an angular frequency of ω₁+Δω (wavelength: λ_{CARS}).

In this process, the existence of the vibrational level ν₁ is a major assumption. Apart from the probe light, upon incidence of the quench light at a different wavelength (angular frequency: ω_{q}, wavelength: λ_{q}), the intermediate level of the vibrational level ν₁ couples with the quench light and generates a sum frequency beam (angular frequency: ω_{q}+Δω), wavelength: λₒᵤₜ). As a result, this beam competes with the CARS beam generated by the original angular frequency (ω₁+Δω), and the CARS beam intensity diminishes. In other words, the vibrational level ν₁ is used to separate the CARS beam and the sum frequency beam (angular frequency: ω_{q}+Δω).

Since the intensity of the sum frequency beam is proportional to the intensity of the quench light, the intensity of the CARS beam diminishes proportionally. In other words, the CARS beam is suppressed at the border of the hollow quench light, thereby obtaining resolution that exceeds the diffraction limit, as with fluorescence suppression type super-resolution microscopy. As a result, multifaceted information, such as the molecular vibration state or the chemical bonding state in the sample S, can be obtained.

As a method for more effectively suppressing the CARS beam, it is also possible to use a method based on spectroscopic principles or a method focusing on the function of a laser.

In a method based on spectroscopic principles, the frequency of the quench light is adjusted, and the sum frequency beam is set higher than the electronically-excited state S₁ of the sample molecules. As a result, the sum frequency beam is caused to resonate with the electronically-excited state S₁, inducing a transition between electronic states. In other words, the irradiated quench light has a frequency corresponding to a larger excitation energy than the transition energy from the ground state S₀ to the electronically-excited state S₁. As a result, the CARS beam can reliably be suppressed with a large absorption cross-section and a weak irradiation intensity (for example, see S. Koura, K. Inoue, T. Omari, M. Ishihara, M. Kikuchi, M. Fuji, and M. Sakai, Opt. Express, 18, 13402 (2010), and M. Sakai, M. Fuji, Chem. Phys. Lett. 396 (2004) 298).

A method focusing on the function of a laser uses the properties of a super continuum light source. A super continuum light source can generate high-brightness coherent light in a continuous wavelength band. Accordingly, the sum frequency beam can be generated at a variety of branching ratios by irradiating the quench light over such a broad band, thereby relatively suppressing the CARS beam.

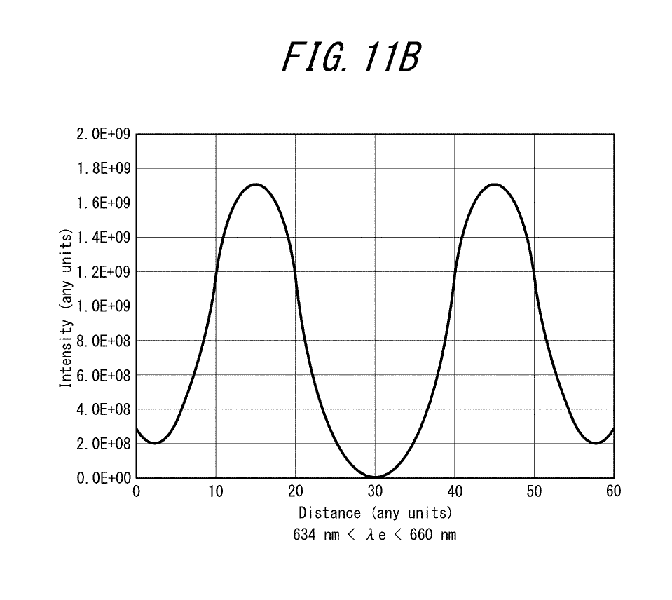

FIG. 11A illustrates the intensity distribution of a concentrated light pattern on the focal plane of quench light when using a line-oscillation laser beam. FIG. 11B illustrates the intensity distribution of a concentrated light pattern on the focal plane of quench light when using a white laser beam from a super continuum light source. FIG. 11A illustrates the case of the wavelength λ_{q} of the quench light satisfying 646 nm<λ_{q}<647 nm. FIG. 11B illustrates the case of the central wavelength of the wavelength λ_{q} being 647 nm, with the bandwidth being approximately 30 nm to satisfy 634 nm<λ_{q}<660 nm. In either case, the spatial modulator 17 illustrated in FIG. 2 has the configuration illustrated in FIG. 5.

As a comparison of FIG. 11A and FIG. 11B shows, the intensity at the central portion of the quench light focused on the focal plane is zero even when a broad band quench light from a white laser beam is dispersed and used. Accordingly, a white laser beam can be suitably used as the quench light of a super-resolution microscope, and by taking advantage of the characteristics of the white laser beam, the sample S can efficiently be irradiated.

(Modification)

Focusing on the excitation diagram in FIG. 10, the following modification is possible. The quench light with angular frequency ω_{q} may be used as the Stokes light, and conversely, the Stokes light with angular frequency ω₂ may be used as the quench light.

In this case, the quench light with angular frequency ω_{q} is focused as a regular Gaussian beam, without being subjected to beam shaping. On the other hand, the Stokes light with angular frequency ω₂ is formed to be hollow and is focused. The sum frequency beam (angular frequency: ω_{q}+Δω) is detected and imaged at each focused spot. In this case, if the intensity of the Stokes light with angular frequency ω₂ increases, the intensity of the sum frequency beam is suppressed, allowing super-resolution microscope observation.

### Embodiment 2

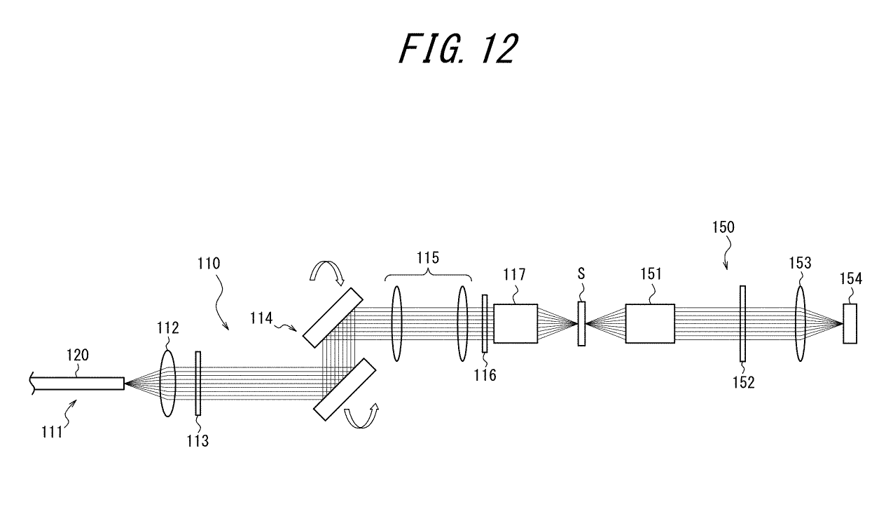

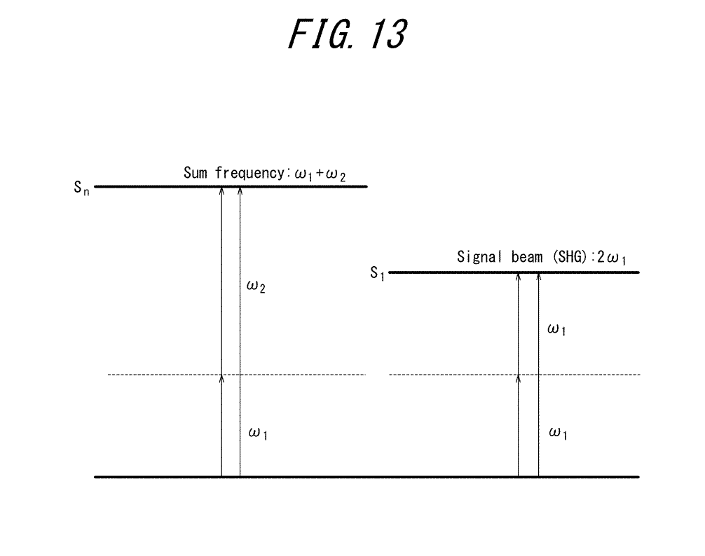

FIG. 12 illustrates the configuration of a super-resolution microscope according to Embodiment 2 of this disclosure. As in FIG. 2, the super-resolution microscope illustrated in FIG. 12 constitutes a CARS microscope and includes an illuminator 110 and a detector 150. The illuminator 110 includes a light source 111, a collimator lens 112, a multi-bandpass filter 113, a galvano mirror optical system 114, a pupil projection lens 115, a spatial modulator 116, and an objective lens 117.

The light source 111 includes a plurality of super continuum light sources. In principle, a super continuum light source extracts white light, from a fiber end face, generated in a photonic crystal fiber by a nonlinear optical effect and extracts an illumination beam of a required wavelength with a dispersive optical element (such as a diffraction grating or a spectral filter). In this embodiment, the photonic crystal fiber tips of a plurality of super continuum light sources are bundled together to form a multi-fiber bundle 120. Using the emission tip of the multi-fiber bundle 120 as a plurality of light source points, a white light multibeam is emitted from the plurality of light source points.

The white light multibeam emitted from the plurality of light source points of the multi-fiber bundle 120 is converted to a coaxial parallel beam by the collimator lens 112 and is then incident on the multi-bandpass filter 113. From the incident white light, the multi-bandpass filter 113 extracts a three-colored illumination beam composed of i) the pump light (probe light) and the Stokes light, which correspond to the ω₁ beam and the ω₂ beam and are the first illumination beam, and ii) the quench light, which is the second illumination beam.

The three-colored illumination beam extracted from the multi-bandpass filter 113 is subjected to deflection scanning in two dimensions by the galvano mirror optical system 114, passes through the pupil projection lens 115 and the spatial modulator 116, and is focused on the sample S as multi-spots by the objective lens 117. The spatial modulator 116 is, for example, configured as illustrated in FIG. 4 and modulates the polarization state or the phase states so that, in correspondence with each of the multi-spots formed on the sample S, the pump light (probe light) and the Stokes light are focused in a Gaussian state, and the quench light is focused in a hollow state. As a result, in each of the multi-spots formed on the sample S, the minimum in the light intensity at the hollow center of the quench light matches the maximum in the light intensity of the pump light (probe light) and the Stokes light.

The detector 150 includes a collection lens 151, a spectral filter 152, a focusing lens 153, and a two-dimensional detector 154. The collection lens 151 collects the CARS beam, which is forward scattered light from the multi-spots on the sample S, and converts the CARS beam to a parallel beam. From the CARS beam converted to a parallel beam by the collection lens 151, a desired wavelength component is extracted by the spectral filter 152 and is focused by the focusing lens 153 as multi-spots on the two-dimensional detector 154. The two-dimensional detector 154 may be configured using a highly sensitive charge coupled device (CCD) sensor, for example, that has a greater number of pixels than the number of multi-spots formed on the sample S.

According to this embodiment, the multi-spots formed on the sample S are scanned by the galvano mirror optical system 114 in two dimensions within the converging surface of the objective lens 117, and the CARS beam from the multi-spots is detected by the two-dimensional detector 154. Therefore, the sample S can be measured at super high speed and at super resolution, allowing live observation of biological phenomena.

This disclosure is not limited to the above embodiments, and a variety of changes and modifications may be made. For example, in Embodiment 1, the two-dimensional scanning in the xy-directions of the sample S may be performed using a galvano mirror optical system as in Embodiment 2. In Embodiment 2, a three-dimensional super resolution microscopic image may be obtained by displacing the sample S in the direction of the optical axis of the objective lens 117. In this case, the sample S may be mounted on a sample stage displaceable in three dimensions, as in Embodiment 1, instead of using the galvano mirror optical system 114. Furthermore, the modification described in Embodiment 1 may also be adopted in Embodiment 2 as well.

In the above embodiment, since illumination beams of three colors are focused on the sample, generation processes and the like of a variety of second order and/or third order sum frequencies resulting from combinations of these illumination beams also compete. In the above embodiment, such generation processes and the like of second order and/or third order sum frequencies can also be used to suppress the CARS beam, thereby allowing broader super-resolution microscopy. In this disclosure, a signal beam generated by a fourth order or fifth order nonlinear effect or the like can also be effectively applied if the competition process can be artificially induced by quench light with a different wavelength than the above wavelength.

Since a nonlinear optical effect of the CARS process is used in the above embodiment, laser beams of three colors including the quench light are used. When using a nonlinear optical effect of an SHG photon generation process, however, laser beams of two colors may be used to allow super-resolution microscope observation. FIG. 13 is an excitation diagram in this case.

In FIG. 13, the quantum level of a molecule in a high electronically-excited state in the condensed phase, for example, is broad. In this case, as the angular frequency ω₁ of the excitation light, a sum frequency that is twice the frequency, i.e. 2ω₁, is generated if an energy level corresponding to twice the frequency exists.

When irradiating excitation light of a different angular frequency ω₂, however, the sum frequency ω₂+ω₁ is also generated if an energy level corresponding to the angular frequency ω₂+ω₁ exists. In this case, the ω₁ beam combines with the ω₂ beam, so that the intensity of the 2ω₁ signal beam decreases in this region. In other words, in this case, the excitation light of the angular frequency ω₂ becomes the quench light (second illumination beam). As a result, the super-resolution microscope can be configured with a nonlinear optical effect using only laser beams of two colors.

In particular, coupling between ω₁ and ω₂ easily occurs when the electronic state S₁ and the electronic state Sₙ are included, as illustrated in FIG. 13, and a reduction in signal beam intensity due to the weak illumination beam can be induced. When the illumination beam uses a picosecond or femtosecond laser beam with a highly intense initial value, however, a sum frequency or harmonic can be generated by the combination of any wavelengths of laser beams of at least two colors, even if the electronic state S₁ and the electronic state Sₙ do not resonate. Hence, this disclosure can be widely applied.

1. A super-resolution microscope comprising:
an illuminator configured to irradiate illumination beams of a plurality of colors of different wavelengths through an objective lens onto a sample while causing the illumination beams to overlap at least spatially; and
a detector configured to detect a signal beam generated by the sample as a result of irradiation of the sample with the illumination beams, wherein
as the illumination beams, the illuminator irradiates a first illumination beam and a second illumination beam onto the sample from the same direction, the first illumination beam comprising a plurality of wavelengths or monochromatic light for inducing a nonlinear optical effect in the sample, and the second illumination beam having a different wavefront distribution on a converging surface of the objective lens or a different spatial distribution of an electrical field vector than the first illumination beam and suppressing induction of the nonlinear optical effect, and
the detector detects a signal beam generated by the sample as a result of the nonlinear optical effect.

2. The super-resolution microscope of claim 1, wherein
the nonlinear optical effect is generated during a process selected from the group consisting of a second-order nonlinear optical process, a third-order nonlinear optical process, a fourth-order nonlinear optical process, and a fifth-order nonlinear optical process,
the second-order nonlinear optical process is selected from the group consisting of second harmonic generation, sum frequency generation, difference frequency generation, and an optical parametric process,
the third-order nonlinear optical process is selected from the group consisting of third harmonic generation, third-order sum frequency generation, coherent anti-Stokes Raman scattering, stimulated Raman scattering, stimulated Raman gain, stimulated Raman loss, optical Kerr effect, Raman induced Kerr effect, stimulated Rayleigh scattering, stimulated Brillouin scattering, stimulated Kerr scattering, stimulated Rayleigh-Bragg scattering, stimulated Mie scattering, self phase modulation, cross phase modulation, optical-field induced birefringence, and electric-field induced second harmonic generation,
the fourth-order nonlinear optical process is four-wave mixing, and
the fifth-order nonlinear optical process is selected from the group consisting of hyper-Raman scattering, hyper-Rayleigh scattering, and coherent anti-Stokes hyper-Raman scattering.

3. The super-resolution microscope of claim 1, wherein the second illumination beam has a minimum in an intensity distribution on the converging surface.

4. The super-resolution microscope of claim 3, wherein the first illumination beam has a maximum in the intensity distribution on the converging surface.

5. The super-resolution microscope of claim 4, wherein
the first illumination beam and the second illumination beam are coherent beams, and
the illuminator comprises a spatial modulator configured to modulate a phase or a spatial distribution of an electrical field vector of the second illumination beam.

6. The super-resolution microscope of claim 5, wherein the spatial modulator modulates the phase or the spatial distribution of the electric field vector of only the second illumination beam when the first illumination beam and the second illumination beam are coaxially incident.

7. The super-resolution microscope of claim 6, wherein the illuminator causes the maximum of the first illumination beam and the minimum of the second illumination beam to overlap coaxially at the converging surface.

8. The super-resolution microscope of claim 1, wherein the detector detects forward scattered light from the sample as the signal beam.

9. The super-resolution microscope of claim 8, wherein the nonlinear optical effect is selected from the group consisting of a nonlinear Raman effect, a second-order or third-order sum frequency generation effect, and a second-order or third-order difference frequency generation effect.

10. The super-resolution microscope of claim 7, wherein the first illumination beam comprises illumination beams of at least two colors of different wavelengths, and the illumination beams of at least two colors have respective maximums in the intensity distribution on the converging surface.

11. The super-resolution microscope of claim 7, wherein the spatial modulator changes the phase of the second illumination beam from 0 to 2π, or an integer multiple thereof, over one revolution centering on an optical axis of the second illumination beam.

12. The super-resolution microscope of claim 7, wherein the spatial modulator includes a plurality of concentric regions centering on an optical axis of the second illumination beam and inverts a sign of the phase of the second illumination beam in a radial direction between adjacent regions.

13. The super-resolution microscope of claim 12, wherein in each of the regions, the spatial modulator changes the phase of the second illumination beam from 0 to 2π, or an integer multiple thereof, over one revolution centering on the optical axis of the second illumination beam.

14. The super-resolution microscope of claim 7, wherein the spatial modulator inverts a direction of the electrical field vector of the second illumination beam at positions symmetrical about an optical axis of the second illumination beam.

15. The super-resolution microscope of claim 7, wherein the spatial modulator includes a plurality of concentric regions centering on an optical axis of the second illumination beam and inverts a direction of the electrical field vector of the second illumination beam between adjacent regions.

16. The super-resolution microscope of claim 5, wherein the illuminator is capable of changing a wavelength of each of the first illumination beam and the second illumination beam.

17. The super-resolution microscope of claim 5, wherein the second illumination beam has a wavelength interval in a finite band.

18. The super-resolution microscope of claim 5, wherein a wavelength of the second illumination beam is shorter than a wavelength at an absorption end due to electronic transition of a molecule to be observed in the sample.

19. The super-resolution microscope of claim 5, wherein
the illuminator comprises a plurality of light source points, and the first illumination beam and the second illumination beam are extracted from the plurality of light source points and irradiated onto the sample, and
the detector is configured to separate and detect a plurality of the signal beams generated by the sample in correspondence with the plurality of light source points.

20. The super-resolution microscope of claim 19, wherein
the plurality of light source points comprise an emission tip of a multi-fiber bundle in which fibers of a plurality of super continuum light sources are bundled together, and
the detector comprises a two-dimensional detector including pixels equal to or greater in number than the number of fibers in the multi-fiber bundle.
